(19) United States
(12) Patent Application Publication
(10) Pub. No.: US 2013/0290972 A1
(43) Pub. Date: Oct. 31, 2013

(54) WORKLOAD MANAGER FOR MAPREDUCE ENVIRONMENTS

(71) Applicants: Ludmila Cherkasova, Sunnyvale, CA (US); Abhishek Verma, Chapmaign, IL (US)

(72) Inventors: Ludmila Cherkasova, Sunnyvale, CA (US); Abhishek Verma, Chapmaign, IL (US)

(21) Appl. No.: 13/458,069

(22) Filed: Apr. 27, 2012

(51) Int. Cl. G06F 9/50

(52) U.S. Cl. 718/103; 718/104

(57) ABSTRACT

A method of managing workloads in MapReduce environments with a system. The system receives job profiles of respective jobs, wherein each job profile describes characteristics of map and reduce tasks. The map tasks produce intermediate results based on the input data, and the reduce tasks produce an output based on the intermediate results. The jobs are ordered according to performance goals into a hierarchy. A minimum quantity of resources is allocated to each job to achieve its performance goal. A plurality of spare resources are allocated to at least one of the jobs. A new job profile having a new performance goal is then received. Next, it is determined whether the new performance goal can be met without deallocating spare resources. Spare resources are re-allocated form the other jobs to the new job to achieve its performance goal without compromising the performance goals of the other jobs.

### BACKGROUND

Enterprises such as companies, educational organizations, and government agencies may employ relatively large volumes of data that are often subject to analysis. A substantial amount of the data of an enterprise can be unstructured data, which is data that is not in the format used in typical commercial databases, and therefore cannot be processed efficiently.

### DESCRIPTION OF THE DRAWINGS

The detailed description will refer to the following drawings, in which:

FIG. 1 is a block diagram of an embodiment of a system that uses a workload manager for MapReduce environments;

FIGS. 2A-2B are graphs illustrating map tasks and reduce tasks of a job in an example MapReduce environment,;

FIG. 3 is a flow diagram of an embodiment of a method of scheduling execution of tasks of jobs;

FIGS. 4A-4B are graphs illustrating feasible solutions representing respective allocations of map slots and reduce slots;

FIG. 5 is a flow diagram of a method of scheduling execution of tasks of jobs;

FIG. 6 is a flow diagram of a method of executing tasks of jobs; and

FIG. 7 is a flow diagram of another method of executing tasks of jobs.

### DETAILED DESCRIPTION

MapReduce is a programming framework designed for processing large volumes of data, including unstructured data, in parallel by dividing the work into a set of independent tasks that are executed on a distributed computing system. Unstructured data refers to data not formatted according to a format of a relational database management system. An open-source MapReduce framework is Hadoop. The MapReduce framework is increasingly being used across enterprises for distributed, advanced data analytics and for enabling new applications associated with data retention, regulatory compliance, e-discovery, and litigation issues. The infrastructure associated with the MapReduce framework can be shared by various diverse applications, for enhanced efficiency.

A MapReduce framework includes a master node and multiple slave nodes (also referred to as worker nodes). A MapReduce job submitted to the master node is divided into multiple map tasks and multiple reduce tasks, which are executed in parallel by the slave nodes. The map tasks are defined by a map function, while the reduce tasks are defined by a reduce function. Each of the map and reduce functions are user-defined functions that are programmable to perform target functionalities.

The map function processes segments of input data to produce intermediate results, where each of the multiple map tasks (that are based on the map function) process corresponding segments of the input data. For example, the map tasks process input key-value pairs to generate a set of intermediate key-value pairs. The reduce tasks (based on the reduce function) produce an output from the intermediate results. For example, the reduce tasks merge the intermediate values associated with the same intermediate key.

More specifically, the map function takes input key-value pairs (k1, v1) and produces a list of intermediate key-value pairs (k2, v2). The intermediate values associated with the same key k2 are grouped together and then passed to the reduce function. The reduce function takes an intermediate key k2 with a list of values and processes them to form a new list of values (v3), as expressed below.

map(k₁,v₁)→list(k₂,v₂)

reduce(k₂,list(v₂))→list(v₃)

The multiple map tasks and multiple reduce tasks (of multiple jobs) are designed to be executed in parallel across resources of a distributed computing platform.

In a complex system, it can be relatively difficult to efficiently allocate resources to jobs and to schedule the tasks of the jobs for execution using the allocated resources, while meeting performance goals of the jobs. The jobs to be executed in a system can have different performance goals—some jobs can be jobs performed in response to queries where the requesters expect relatively quick responses, while other jobs can be long production jobs (e.g., routine data analysis, etc.) that can run a relatively long time.

Disclosed herein is a system and corresponding method that allow specifying efficient allocations of resources to jobs and to scheduling jobs using the allocated resources in a manner to satisfy performance goals of the jobs. In an example, a scheduler determines job ordering and scheduling of tasks of corresponding jobs. The ordering of jobs can be according to respective performance goals of the jobs. The scheduler also receives as input resource allocations for the respective jobs. The resource allocations are determined based on employing a performance model that takes into account job profiles (of the respective jobs), where the determined allocations are able to satisfy the performance goals associated with the respective jobs. Given the ordering of the jobs and the determined resource allocations, the scheduler is able to schedule tasks of the jobs for execution.

The performance goal associated with a job can be expressed as a target completion time, which can be a specific deadline, or some other indication of a time duration within which the job should be executed. Other performance goals can be used in other examples. For example, a performance goal can be expressed as a service level objective (SLO), which specifies a level of service to be provided (expected performance, expected time, expected cost, etc.).

Although reference is made to the MapReduce framework in some examples, the herein disclosed techniques or mechanisms can be applied in other distributed processing frameworks that employ map tasks and reduce tasks. More generally, “map tasks” are used to process input data to output intermediate results, based on a predefined function that defines the processing to be performed by the map tasks. “Reduce tasks” take as input partitions of the intermediate results to produce outputs, based on a predefined function that defines the processing to be performed by the reduce tasks. The map tasks are considered to be part of a map stage, whereas the reduce tasks are considered to be part of a reduce stage. In addition, although reference is made to unstructured data in some examples, techniques or mechanisms can also be applied to structured data formatted for relational database management systems.

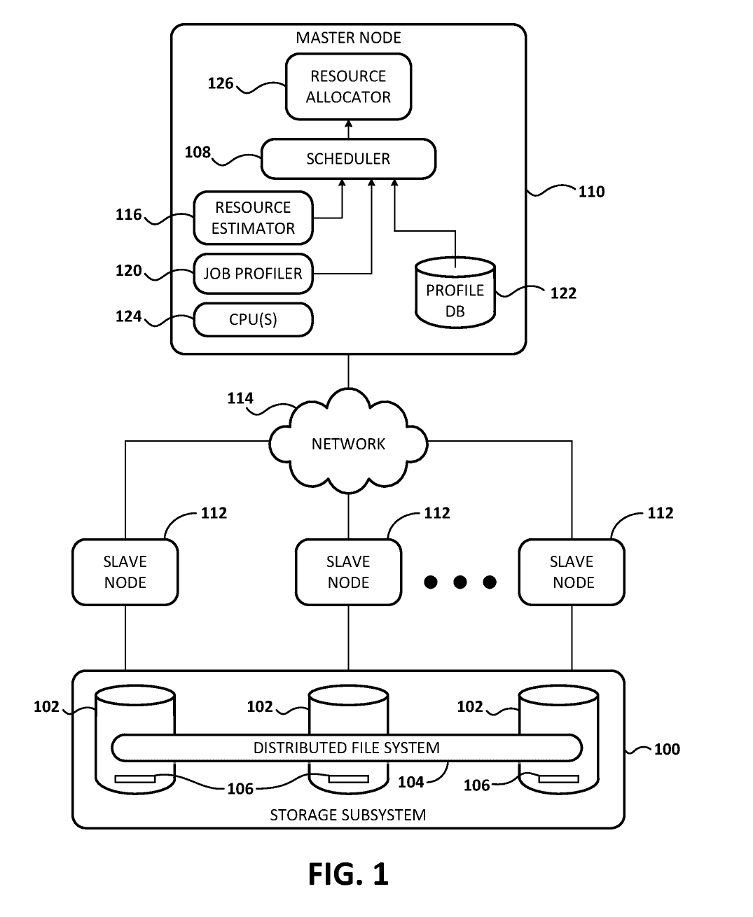

FIG. 1 illustrates an example arrangement that provides a distributed processing framework that includes example mechanisms. As depicted in FIG. 1, a storage subsystem 100 includes multiple storage modules 102, where the multiple storage modules 102 can provide a distributed file system 104. The distributed file system 104 stores multiple segments 106 of input data across the multiple storage modules 102. The distributed file system 104 can also store outputs of map and reduce tasks.

The storage modules 102 can be implemented with storage devices such as disk-based storage devices or integrated circuit storage devices. In some examples, the storage modules 102 correspond to respective different physical storage devices. In other examples, plural ones of the storage modules 102 can be implemented on one physical storage device, where the plural storage modules correspond to different logical partitions of the storage device.

The system of FIG. 1 further includes a master node 110 that is connected to slave nodes 112 over a network 114. The network 114 can be a private network (e.g., a local area network or wide area network) or a public network (e.g., the Internet), or some combination thereof. The master node 110 includes one or multiple central processing units (CPUs) 124. Each slave node 112 also includes one or multiple CPUs (not shown). Although the master node 110 is depicted as being separate from the slave nodes 112, it is noted that in alternative examples, the master node 112 can be one of the slave nodes 112.

A “node” refers generally to processing infrastructure to perform computing operations. A node can refer to a computer, or a system having multiple computers. Alternatively, a node can refer to a CPU within a computer. As yet another example, a node can refer to a processing core within a CPU that has multiple processing cores. More generally, the system can be considered to have multiple processors, where each processor can be a computer, a system having multiple computers, a CPU, a core of a CPU, or some other physical processing partition.

In an example, a scheduler 108 in the master node 110 is configured to perform scheduling of jobs on the slave nodes 112. The slave nodes 112 are considered the working nodes within the cluster that makes up the distributed processing environment.

Each slave node 112 has a corresponding number of map slots and reduce slots, where map tasks are run in respective map slots, and reduce tasks are run in respective reduce slots. The number of map slots and reduce slots within each slave node 112 can be preconfigured, such as by an administrator or by some other mechanism. The available map slots and reduce slots can be allocated to the jobs. The map slots and reduce slots are considered the resources used for performing map and reduce tasks. A “slot” can refer to a time slot or alternatively, to some other share of a processing resource that can be used for performing the respective map or reduce task. Depending upon the load of the overall system, the number of map slots and number of reduce slots that can be allocated to any given job can vary.

The slave nodes 112 may periodically (or repeatedly) send messages to the master node 110 to report the number of free slots and the progress of the tasks that are currently running in the corresponding slave nodes.

Each map task processes a logical segment of the input data that generally resides on a distributed file system, such as the distributed file system 104 shown in FIG. 1. The map task applies the map function on each data segment and buffers the resulting intermediate data. This intermediate data is partitioned for input to the reduce tasks.

The reduce stage (that includes the reduce tasks) has three phases: shuffle phase, sort phase, and reduce phase. In the shuffle phase, the reduce tasks fetch the intermediate data from the map tasks. In the sort phase, the intermediate data from the map tasks are sorted. An external merge sort is used in case the intermediate data does not fit in memory. Finally, in the reduce phase, the sorted intermediate data (in the form of a key and all its corresponding values, for example) is passed on the reduce function. The output from the reduce function is usually written back to the distributed file system 104.

In addition to the scheduler 108, the master node 110 of FIG. 1 includes a job profiler 120 that creates a job profile for a given job. The job profile describes characteristics of map and reduce tasks of the given job to be performed by the system of FIG. 1. A job profile created by the job profiler 120 can be stored in a job profile database 122. The job profile database 122 can store multiple job profiles, including job profiles of jobs that have executed in the past.

The master node 110 also includes a resource estimator 116 that is able to allocate resources, such as numbers map slots and reduce slots, to a job, given a performance goal (e.g., target completion time) associated with the job. The resource estimator 116 receives as input a job profile, which can be a job profile created by the job profiler 120, or a job profile previously stored in the job profile database 122. The resource estimator 116 also uses a performance model that calculates a performance parameter (e.g., time duration of the job) based on the characteristics of the job profile, a number of map tasks of the job, a number of reduce tasks of the job, and an allocation of resources (e.g., number of map slots and number of reduce slots).

Using the performance parameter calculated by the performance model, the resource estimator 116 is able to determine feasible allocations of resources to assign to the given job to meet the performance goal associated with the given job. As noted above the performance goal may be expressed as a target completion time, which can be a target deadline or a target time duration, by or within which the job is to be completed. The performance parameter that is calculated by the performance model may be a time duration value corresponding to the amount of time the job would take assuming a given allocation of resources. The resource estimator 116 is able to determine whether any particular allocation of resources can meet the performance goal associated with a job by comparing a value of the performance parameter calculated by the performance model to the performance goal.

As noted above, the resource estimator 116 is able to calculate multiple feasible solutions of allocations of resources to perform a given job, where a “feasible solution” refers to an allocation of resources that allows a system to execute the given job while satisfying the performance goal associated with the given job. The multiple feasible solutions of allocations of resources for the given job can be added to a set of feasible solutions. Then, using some predefined criterion, one of the feasible solutions can be selected from the set to determine a specific allocation of resources for the given job.

The resource estimator 116 may be able to select one of the feasible solutions that is associated with a minimum amount of allocated resources (e.g. minimum total number of map and reduce slots) that allows the given job to meet its performance goal. The selection of the feasible solution with the minimum amount of allocated resources may use a Lagrange's multiplier technique, which is a technique that finds a maxima or minima of a function subject to constraints. The Lagrange's multiplier technique is discussed further below. The resource estimator 116 may use other techniques for selecting from among multiple feasible solutions for output as a selected solution that includes a specific allocation of resources.

As shown in FIG. 1, the scheduler 108 receives the following inputs: job profiles from the job profiler 120 and/or profile database 122, and a specific allocation of resources from the resource estimator 116.

The scheduler 108 is able to listen for events such as job submissions, heartbeats from the slave nodes 118 (indicating availability of map and/or reduce slots, and/or other events). The scheduling functionality of the scheduler 108 can be performed in response to detected events.

The scheduler 108 is able to order the jobs to be executed according to performance goals of the respective jobs. For example, if the performance goals are corresponding deadlines of the jobs, the scheduler 108 is able to employ an earliest deadline first technique to perform job ordering, where the job with the earliest deadline is ordered ahead of other jobs. Effectively, the earliest deadline first technique orders jobs starting with the job having the earliest deadline, and progressing to the job with the latest deadline. Alternately, other ordering techniques for ordering a collection of jobs may be used.

According to the allocated amount of resources for each job and the ordering of the jobs, the scheduler 108 is able to schedule tasks of jobs to respective map and reduce slots. There may also be different classes of jobs, including jobs with deadlines and jobs without deadlines. The scheduler 108 can assign jobs with deadlines higher priorities over jobs without deadlines. However, once jobs with deadlines are assigned their respective allocations of map and reduce slots, the remaining slots can be distributed to other classes of jobs.

The scheduling of job tasks in respective slots (as performed by the scheduler 108) is provided as output to a resource allocator 126, which performs the assignment of tasks to respective slots (according to the scheduling). The resource allocator 126 ensures that the number of map and reduce slots assigned to any given job remains below allocated numbers for each given job as provided by the resource estimator 116. Note that if there are spare slots that are unused, the resource allocator 126 can employ further policy to use such slots for performing tasks of jobs.

Although the scheduler 108 and resource allocator 126 are depicted as separate modules in FIG. 1; however, the functionalities of the scheduler 108 and resource allocator 126 may be combined into one module. Alternatively, the functionalities of the resource estimator 116 and/or job profiler 120 can also be combined with another module. Also, although each of the modules 108, 116, 120, 126, and 122 are depicted as being part of the master node 110, it is noted that some of such modules can be deployed on another node.

The performance goal associated with a job may be a target completion time (a deadline or time duration of the job). However, it may alternately be any other performance goal.

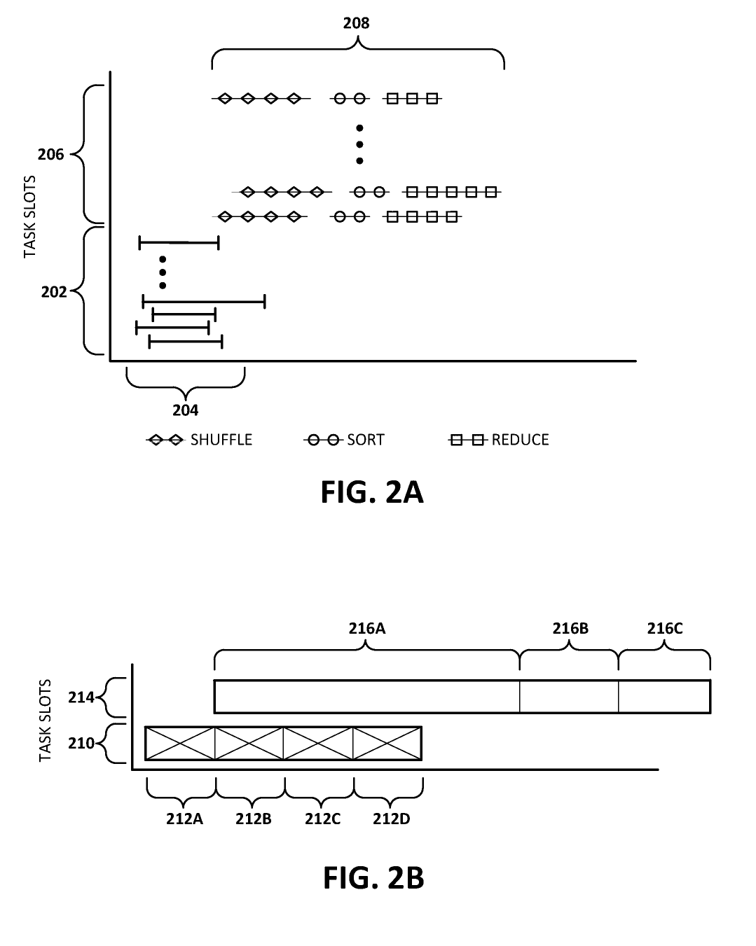

FIGS. 2A and 2B illustrate differences in completion times of performing map and reduce tasks of a given job due to different allocations of map slots and reduce slots. FIG. 2A illustrates an example in which there are 64 map slots and 64 reduce slots allocated to the given job. The example also assumes that the total input data to be processed for the given job can be separated into 64 partitions. Since each partition is processed by a corresponding different map task, the given job includes 64 map tasks. Similarly, 64 partitions of intermediate results output by the map tasks can be processed by corresponding 64 reduce tasks. Since there are 64 map slots allocated to the map tasks, the execution of the given job can be completed in a single map wave.

As depicted in FIG. 2A, the 64 map tasks are performed in corresponding 64 map slots 202, in a single wave (represented generally as 204). Similarly, the 64 reduce tasks are performed in corresponding 64 reduce slots 206, also in a single reduce wave 208, which includes shuffle, sort, and reduce phases represented by different line patterns in FIG. 2A.

A “map wave” refers to an iteration of the map stage. If the number of allocated map slots is greater than or equal to the number of map tasks, then the map stage can be completed in a single iteration (single wave). However, if the number of map slots allocated to the map stage is less than the number of map tasks, then the map stage would have to be completed in multiple iterations (multiple waves). Similarly, the number of iterations (waves) of the reduce stage is based on the number of allocated reduce slots as compared to the number of reduce tasks.

FIG. 2B illustrates a different allocation of map slots and reduce slots. Assuming the same given job (input data that is divided into 64 partitions), if the number of resources allocated is reduced to 16 map slots and 22 reduce slots, for example, then the completion time for the given job will change (increase). FIG. 2B illustrates execution of map tasks in the 16 map slots 210. In FIG. 2B, instead of performing the map tasks in a single wave as in FIG. 2A, the example of FIG. 2B illustrates four waves 212A, 212B, 212C, and 212D of map tasks. The reduce tasks are performed in the 22 reduce slots 214, in three waves 216A, 216B, and 216C. The completion time of the given job in the FIG. 2B example is greater than the completion time in the FIG. 2A example, since a smaller amount of resources was allocated to the given job in the FIG. 2B example than in the FIG. 2A example.

Thus, it can be observed from the examples of FIGS. 2A and 2B that the execution times of any given job can vary when different amounts of resources are allocated to the job.

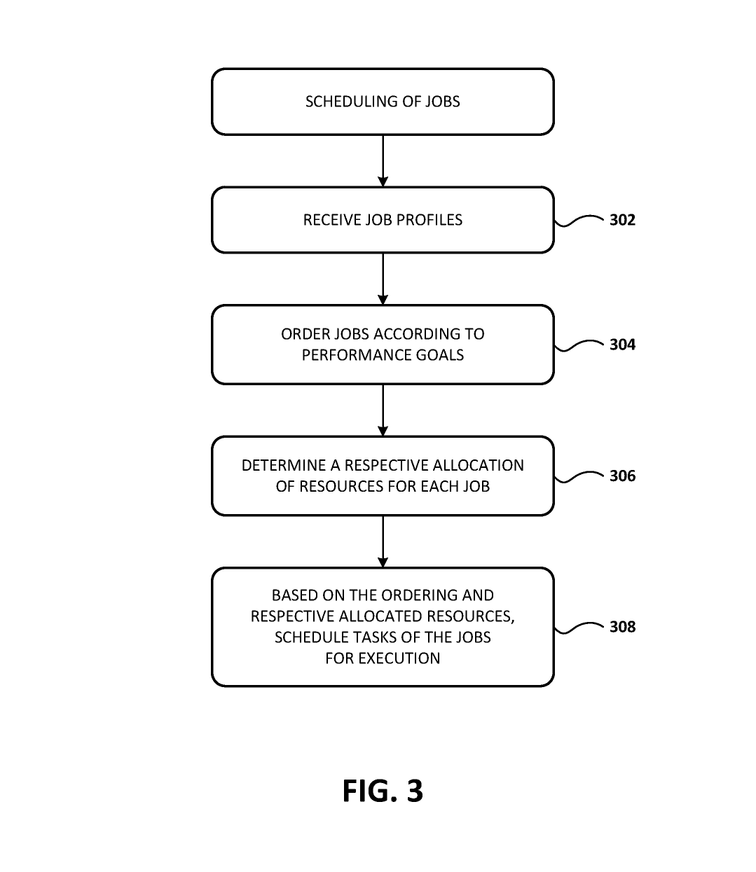

FIG. 3 is a flow diagram of a process of scheduling jobs for execution as performed by the master node 110 of FIG. 1. The process includes receiving (at 302) job profiles that define characteristics of respective jobs to be executed. The jobs that are to be executed are ordered (at 304) according to respective performance goals (e.g., deadlines) of respective ones of the jobs. For example, as noted above, the ordering can be based on using an earliest deadline first technique. The ordering can be performed by the scheduler 108 (FIG. 1).

The master node 110 also determines (at 306) a respective allocation of resources for each of the jobs based on the corresponding job profile. This task can be performed by the resource estimator 116. For example, the resource estimator 116 can select an allocation of resources (e.g. number of map slots and number of reduce slots) for each job by selecting the allocation with the minimum amount of resources (e.g. minimum total number of map and reduce slots). The selected allocation can be from among multiple feasible solutions.

Based on the ordering of the jobs and the respective allocated amounts of resources for the jobs, the scheduler can schedule (at 308) tasks (including map tasks and reduce tasks) of the jobs for execution.

Further details regarding the job profile, performance model, determination of solutions of resource allocations, and scheduling of job tasks are discussed below.

A job profile reflects performance invariants that are independent of the amount of resources assigned to the job over time, for each of the phases of the job: map, shuffle, sort, and reduce phases. The job profile properties for each of such phases are provided below.

The map stage includes a number of map tasks. To characterize the distribution of the map task durations and other invariant properties, the following metrics can be specified in some examples:

(Mₘᵢₙ,M_{avg},Mₘₐₓ,AvgSize_{M}^{input},Selectivity_{M}), where
Mₘᵢₙ is the minimum map task duration. Since the shuffle phase starts when the first map task completes, Mₘᵢₙ is used as an estimate for the shuffle phase beginning.
M_{arg} is the average duration of map tasks to indicate the average duration of a map wave.
Mₘₐₓ is the maximum duration of a map task. Since the sort phase of the reduce stage can start only when the entire map stage is complete, i.e., all the map tasks complete, Mₘₐₓ is used as an estimate for a worst map wave completion time.
AvgSize_{M}^{input} is the average amount of input data for a map stage. This parameter is used to estimate the number of map tasks to be spawned for a new data set processing.
Selectivity_{M} is the ratio of the map data output size to the map data input size. It is used to estimate the amount of intermediate data produced by the map stage as the input to the reduce stage (note that the size of the input data to the map stage is known).

As described earlier, the reduce stage includes the shuffle, sort and reduce phases. The shuffle phase begins only after the first map task has completed. The shuffle phase (of any reduce wave) completes when the entire map stage is complete and all the intermediate data generated by the map tasks have been shuffled to the reduce tasks.

The completion of the shuffle phase is a prerequisite for the beginning of the sort phase. Similarly, the reduce phase begins only after the sort phase is complete. Alternately, instead of performing the shuffle and sort phases of the reduce stage in sequence, for enhanced performance efficiency, the shuffle and sort phases of the reduce stage can be interleaved. The profiles of the shuffle, sort, and reduce phases are represented by their average and maximum time durations. In addition, for the reduce phase, the reduce selectivity, denoted as Selectivity_{R}, is computed, which is defined as the ratio of the reduce data output size to its data input size.

The shuffle phase of the first reduce wave may be different from the shuffle phase that belongs to the subsequent reduce waves (after the first reduce wave). This can happen because the shuffle phase of the first reduce wave overlaps with the map stage and depends on the number of map waves and their durations. Therefore, two sets of measurements are collected: (Sh_{avg}¹,Shₘₐₓ¹) for a shuffle phase of the first reduce wave (referred to as the “first shuffle phase”), and (Sh_{avg}^{typ},Shₘₐₓ^{typ}) for the shuffle phase of the subsequent reduce waves (referred to as “typical shuffle phase”). Since techniques are looking for the performance invariants that are independent of the amount of allocated resources to the job, a shuffle phase of the first reduce wave is characterized in a special way and the parameters (Sh_{avg}¹ and Shₘₐₓ¹) reflect only wdurations of the non-overlapping portions (non-overlapping with the map stage) of the first shuffle. In other words, the durations represented by Sh_{avg}¹ and Shₘₐₓ¹ represent portions of the duration of the shuffle phase of the first reduce wave that do not overlap with the map stage.

The job profile in the shuffle phase is characterized by two pairs of measurements:

(Sh_{avg}¹,Shₘₐₓ¹),(Sh_{avg}^{typ},Shₘₐₓ^{typ}).

If the job execution has only a single reduce wave, the typical shuffle phase duration is estimated using the sort benchmark (since the shuffle phase duration is defined entirely by the size of the intermediate results output by the map stage).

A performance model used for determining a feasible allocation of resources for a job calculates a performance parameter. The performance parameter may be expressed as an upper bound parameter or a lower bound parameter or some determined intermediate parameter between the lower bound and upper bound (e.g. average of the lower and upper bounds). If the performance parameter is a completion time value, the lower bound parameter may be a lower bound completion time, the upper bound parameter is an upper bound completion time, and the intermediate performance parameter is an intermediate completion time (e.g. average completion time that is an average of the upper and lower completion). However, instead of calculating the average of the upper bound and lower bound to provide the intermediate performance parameter, a different intermediate parameter can be calculated, such as a value based on a weighted average of the lower and upper bounds or application of some other predefined function on the lower and upper bounds.

In some examples, the lower and upper bounds are for a makespan (a completion time of the job) of a given set of n (n>1) tasks that are processed by k (k>1) servers (or by k slots in a MapReduce environment). Let T1, T2, . . . , Tn be the durations of n tasks of a given job. Let k be the number of slots that can each execute one task at a time. The assignment of tasks to slots is done using a simple, online, greedy algorithm, e.g. assign each task to the slot with the earliest finishing time.

Let μ=(Σᵢ₌₁ⁿTᵢ)/n and λ=maxᵢ {Tᵢ} be the mean and maximum durations of the n tasks, respectively. The makespan of the greedy task assignment is at least n·μ/k and at most (n−1)·μ/k+λ. We call this statement as a Makespan Theorem. The lower bound is trivial, as the best case is when all n tasks are equally distributed among the k slots (or the overall amount of work n·μ is processed as fast as it can by k slots). Thus, the overall makespan (completion time of the job) is at least n·μ/k (lower bound of the completion time).

For the upper bound of the completion time for the job, the worst case scenario is considered, i.e., the longest task (T)ε(T₁, T₂, . . . , Tₙ) with duration λ is the last task processed. In this case, the time elapsed before the last task is scheduled is (Σᵢ₌₁ⁿ⁻¹Tᵢ)/k≦(n−1)·μ/k. Thus, the makespan of the overall assignment is at most (n−1)·μ/k+λ. These bounds are particularly useful when λ<<n·μ/k, in other words, when the duration of the longest task is small as compared to the total makespan.

The difference between lower and upper bounds (of the completion time) represents the range of possible job completion times due to non-determinism and scheduling. As discussed below, these lower and upper bounds, which are part of the properties of the performance model, are used to estimate a completion time for a corresponding job J.

The given job J has a given profile created by the job profiler 120 (FIG. 1) or extracted from the profile database 122. Let J be executed with a new input dataset that can be partitioned into N_{M} map tasks and N_{R} reduce tasks. Let S_{M} and S_{R} be the number of map slots and number of reduce slots, respectively, allocated to job J.

Let M_{avg} and Mₘₐₓ be the average and maximum time durations of map tasks (defined by the job J profile). Then, based on the Makespan theorem, the lower and upper bounds on the duration of the entire map stage (denoted as T_{M}^{low} and T_{M}^{up}, respectively) are estimated as follows:

T_{M}^{low}N_{M}^{J}/S_{M}^{J}·M_{avg}, (Eq. 1)

T_{M}^{up}=(N_{M}^{J}−1)/S_{M}^{J}·M_{avg}+Mₘₐₓ. (Eq. 2)

The “J” superscript in N_{M}^{J} and S_{M}^{J} indicates that the respective parameter is associated with job J. Stated differently, the lower bound of the duration of the entire map stage is based on a product of the average duration (M_{avg}) of or map tasks multiplied by the ratio of the number of map tasks (N_{M}^{J}) to the number of allocated map slots (S_{M}^{J}). The upper bound of the duration of the entire map stage is based on a sum of the maximum duration of map tasks (Mₘₐₓ) and the product of M_{avg} with (N_{M}^{J}−1)/S_{M}^{J}. Thus, it can be seen that the lower and upper bounds of durations of the map stage are based on properties of the job J profile relating to the map stage, and based on the allocated number of map slots.

The reduce stage includes shuffle, sort and reduce phases. Similar to the computation of the lower and upper bounds of the map stage, the lower and upper bounds of time durations for each of the shuffle phase (T_{Sh}^{low},T_{Sh}^{up}), sort phase (T_{Sort}^{low},T_{Sort}^{up}), and reduce phase (T_{R}^{low},T_{R}^{up}) are computed. The computation of the Makespan theorem is based on the average and maximum durations of the tasks in these phases (respective values of the average and maximum time durations of the shuffle phase, the average and maximum time durations of the sort phase, and the average and maximum time duration of the reduce phase) and the numbers of reduce tasks N_{R} and allocated reduce slots S_{R}, respectively. The formulae for calculating (T_{Sh}^{low},T_{Sh}^{up}), (T_{Sort}^{low},T_{Sort}^{up}), and (T_{R}^{low},T_{R}^{up}) are similar to the formulae for calculating T_{M}^{up} and T_{M}^{up} set forth above, except variables associated with the reduce tasks and reduce slots and the respective phases of the reduce stage are used instead.

The subtlety lies in estimating the duration of the shuffle phase. As noted above, the first shuffle phase is distinguished from the task durations in the typical shuffle phase (which is a shuffle phase subsequent to the first shuffle phase). As noted above, the first shuffle phase includes measurements of a portion of the first shuffle phase that does not overlap the map stage. The portion of the typical shuffle phase in the subsequent reduce waves (after the first reduce wave) is computed as follows:

$$\begin{matrix}{T}_{Sh}^{low} = ( \frac{{N}_{R}^{J}}{{S}_{R}^{J}} - 1 ) \cdot {Sh}_{avg}^{typ} , & ( Eq . 3 ) \\ {T}_{Sh}^{up} = ( \frac{{N}_{R}^{J} - 1}{{S}_{R}^{J}} - 1 ) \cdot {Sh}_{avg}^{typ} + {Sh}_{max}^{typ} . & ( Eq . 4 )\end{matrix}$$

where Sh_{avg}^{typ} is the average duration of a typical shuffle phase, and Shₘₐₓ^{typ} is the average duration of the typical shuffle phase. The formulae for the lower and upper bounds of the overall completion time of job J are as follows:

T_{J}^{low}=T_{M}^{low}+Sh_{avg}¹+T_{Sh}^{low}+T_{Sort}^{low}+T_{R}^{low}, (Eq. 5)

T_{J}^{up}=T_{M}^{up}+Shₘₐₓ¹+T_{Sh}^{up}+T_{Sort}^{up}+T_{R}^{up}, (Eq. 6)

where Sh_{avg}¹ is the average duration of the first shuffle phase, and Shₘₐₓ¹ is the maximum duration of the first shuffle phase. T_{J}^{low} and T_{J}^{up} represent optimistic and pessimistic predictions (lower and upper bounds) of the job J completion time. Thus, it can be seen that the lower and upper bounds of time durations of the job J are based on properties of the job J profile and based on the allocated numbers of map and reduce slots. The properties of the performance model, which include T_{J}^{low} and T_{J}^{up}, are thus based on both the job profile as well as allocated numbers of map and reduce slots.

An intermediate performance parameter value, such as an average value between the lower and upper bounds, T_{J}^{avg} is defined as follows:

T_{J}^{qvg}=(T_{M}^{up}+)T_{J}^{low}/2. (Eq. 7)

Eq. 5 for T_{J}^{low} can be rewritten by replacing its parts with Eq. 1 and Eq. 3 and similar equations for sort and reduce phases as follows:

$${T}_{J}^{low} = \frac{{N}_{M}^{J} \cdot {M}_{avg}}{{S}_{M}^{J}} + \frac{{N}_{R}^{J} \cdot ( {Sh}_{avg}^{typ} + {R}_{avg} )}{{S}_{R}^{J}} + {Sh}_{avg}^{1} - {Sh}_{avg}^{typ} , \qquad ( Eq . 8 )$$

The alternative presentation of Eq. 8 allows the estimates for completion time to be expressed in a simplified form shown below:

$${T}_{J}^{low} = {A}_{J}^{low} \cdot \frac{{N}_{M}^{J}}{{S}_{M}^{J}} + {B}_{J}^{low} \cdot \frac{{N}_{R}^{J}}{{S}_{R}^{J}} + {C}_{J}^{low} , \qquad ( Eq . 9 )$$

where A_{J}^{low}=M_{avg},B_{J}^{low}=(Sh_{avg}^{typ}+R_{avg}), and C_{J}^{low}=Sh_{avg}¹−Sh_{avg}^{typ}. Eq. 9 provides an explicit expression of a job completion time as a function of map and reduce slots allocated to job J for processing its map and reduce tasks, i.e., as a function of (N_{M}^{J},N_{R}^{J}) and (S_{M}^{J},S_{R}^{J}). The equation for T_{J}^{up} and T^{avg J} can be rewritten similarly.

The following discusses how an allocation with a minimum number of map and reduce slots may be determined, using a Lagrange's multiplier technique.

The allocations of map and reduce slots to job J (with a known profile) for meeting deadline T can be found using Eq. 9 or similar equations for the upper bound or the average completion time. A simplified form of this equation is shown below:

$$\frac{a}{m} + \frac{b}{r} = D , \qquad ( Eq . 10 )$$

where m is the number of map slots allocated to the job J, r is the number of reduce slots allocated to the job J, and a, b and D represent the corresponding constants (expressions) from Eq. 9 or similar other equations for T_{J}^{up} and T_{J}^{avg}.

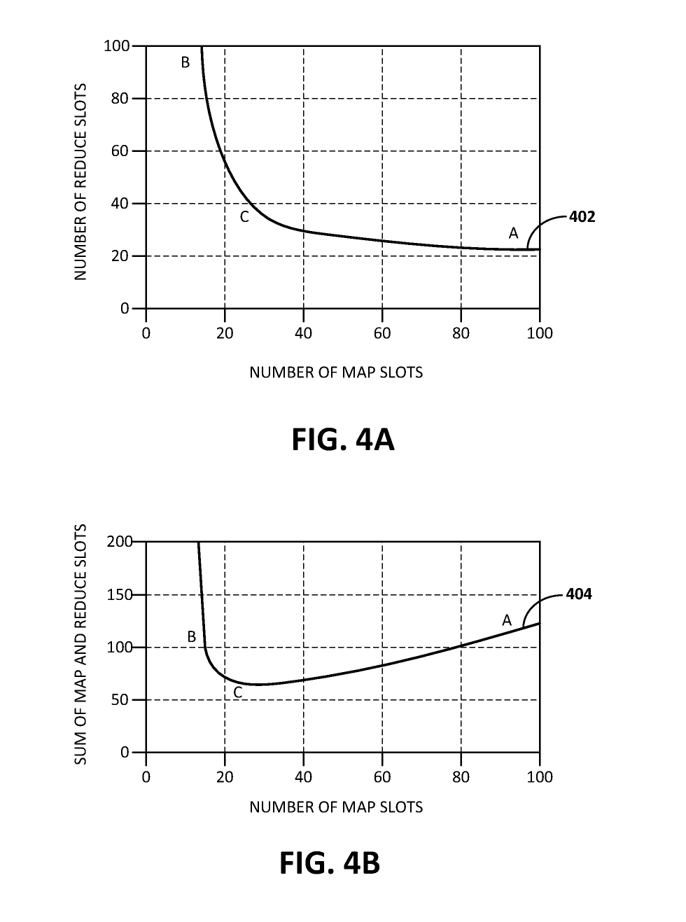

As shown in FIG. 4A, Eq. 10 yields a curve 402 if m and r are the variables. All points on this curve 402 are feasible allocations of map and reduce slots for job J which result in meeting the same deadline T. As shown in FIG. 4A, allocations may include a maximum number of map slots and very few reduce slots (shown as point A along curve 402) or very few map slots and a maximum number of reduce slots (shown as point B along curve 402).

These different feasible resource allocations (represented by points along the curve 402) correspond to different amounts of resources that allow the deadline T to be satisfied. FIG. 4B shows a curve 404 that relates a sum of allocated map slots and reduce slots (vertical axis of FIG. 4B) to a number of map slots (horizontal axis of FIG. 4B). There is a point along curve 404 where the sum of the map and reduce slots is minimized (shown as point C along curve 404 in FIG. 4B). Thus, the resource estimator 116 (FIG. 1) aims to find the point where the sum of the map and reduce slots is minimized (shown as point C). By allocating the allocation with a minimum of the summed number of map slots and reduce slots, the number of map and reduce slots allocated to job J is reduced to allow available slots to be allocated to other jobs.

The minima (C) on the curve 404 may be calculated using Lagrange's multiplier technique. The technique seeks to minimize f(m,r)=m+r that satisfy the equation:

$$\frac{a}{m} + \frac{b}{r} = D .$$

The technique sets

$$Λ = m + r + λ \frac{a}{m} + λ \frac{b}{r} - D ,$$

where λ represents a Lagrange multiplier.

Differentiating Λ partially with respect to m, r and λ and equating to zero, the following are obtained:

$$\begin{matrix}\frac{\partial Λ}{\partial m} = 1 - λ \frac{a}{{m}^{2}} = 0 , & ( Eq . 11 ) \\ \frac{\partial Λ}{\partial r} = 1 - λ \frac{b}{{r}^{2}} = 0 , and & ( Eq . 12 ) \\ \frac{\partial Λ}{\partial λ} = \frac{1}{m} + \frac{b}{r} - D = 0. & ( Eq . 13 )\end{matrix}$$

Solving these equations simultaneously, the variables m and r are obtained:

$$m = \frac{\sqrt{a} ( \sqrt{a} + \sqrt{b} )}{D} , r = \frac{\sqrt{b} ( \sqrt{a} + \sqrt{b} )}{D} . \qquad ( Eq . 14 )$$

These values for m (number of map slots) and r (number of reduce slots) reflect the optimal allocation of map and reduce slots for a job such that the total number of slots used is minimized while meeting the deadline of the job. In practice, the m and r values are integers—hence, the values found by Eq. 14 are rounded up and used as approximations.

An example technique performed by the master node 110 (FIG. 1) is set forth in the following process.

```
1: When job j is added:
2: Fetch Profileⱼ from database
3:  Compute minimum number of map and reduce slots (mⱼ, rⱼ) using
Lagrange's multiplier method
4: When a heartbeat is received from node n:
5: Sort jobs in order of earliest deadline
6: for each slot s in free map/reduce slots
on node n do
7:  for each job j in jobs do
8:  if RunningMapsⱼ < ₘⱼ and s is map slot then
9:  if job j has unlaunched map task t with data on node n then
10:  Launch map task t with local data on node n.
11:  else if j has unlaunched map task t then
12:  Launch map task t on node n
13:  end if
14:  end if
15:  if FinishedMapsⱼ > 0 and s is reduce slot and Running
        Reduces_{J} < r_{J} then
16.  if job j has unlaunched reduce task t then
17.  Launch reduce task t on node n
18.  end if
19.  end if
20.  end for
21. end for
22. for each task Tⱼ finished slots by node n do
23:  Recompute (m_{j,} rⱼ) based on the current time, current progress
        and deadline of job j
24: end for
```

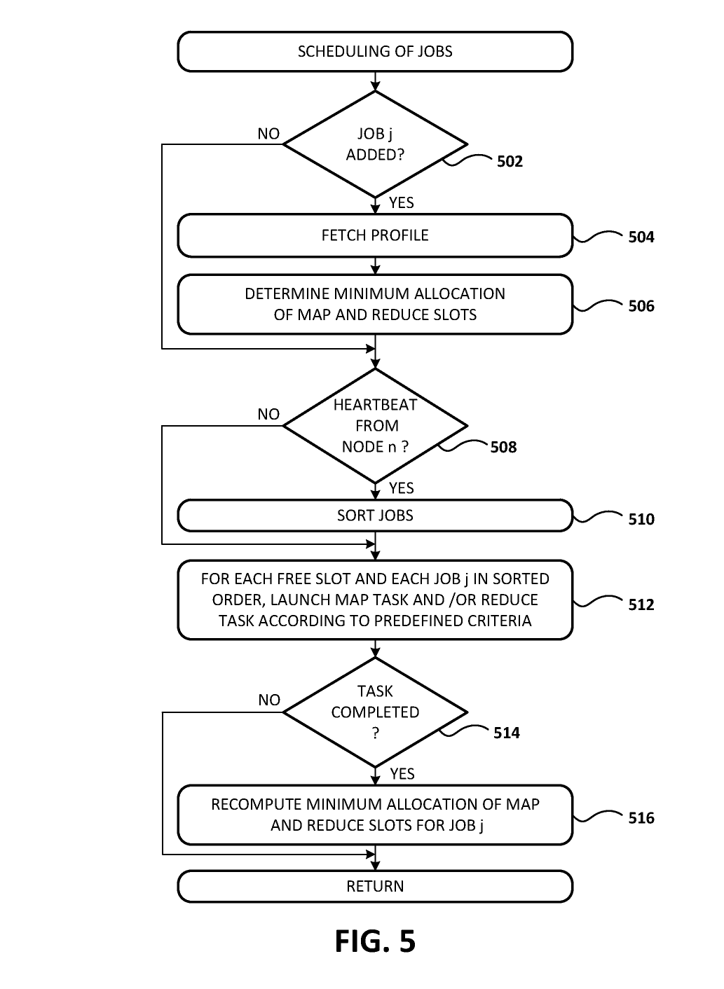

The pseudo-code above is explained in connection with FIG. 5. The process of FIG. 5 may be performed by various modules in the master node 110 of FIG. 1. When a job j is added to the system, as detected at 502 (line 1 of pseudo-code), the respective profile for the job j is fetched (at 504, line 2 of pseudo-code). The profile for job j may be received from the profile database 122 or from the job profiler 120.

The master node 110 also determines (at 506, line 3 of pseudo-code) the minimum allocation of resources (the allocation with the minimum total number of map and reduce slots) for job j, such as by use of the Lagrange's multiplier technique (discussed above). This minimum allocation of resources is represented as (mⱼ, rⱼ), where mⱼ represents the allocated number of map slots, and rⱼ represents the number of reduce slots.

The master node 110 further determines (at 508, line 4 of the pseudo-code) if a heartbeat is received from slave node n. A heartbeat is sent by a slave node to indicate availability of a slot (map slot and/or reduce slot). In response to the heartbeat, the master node 110 orders (at 510, line 5 of the pseudo-code) a data structure jobs, which contains the jobs that are to be executed in the system. The ordering of jobs in the data structure jobs may be in an order of earliest deadline.

Next, for each free slot s (free map slot or free reduce slot) and for each job j in jobs, the master node 110 launches (at 512) map tasks and/or reduce tasks according to predefined criteria, as specified in lines 6-21 of the pseudo-code. Since the jobs in the data structure jobs are sorted according to the deadlines of the jobs, the processing performed at lines 6-21 of the pseudo-code would consider jobs with earlier deadlines before jobs with later deadlines.

Line 8 of the pseudo-code determines if a parameter RunningMapsⱼ is less than the number of map slots allocated to job j (mⱼ), and if the free slot (s) is a map slot. The parameter RunningMapsⱼ represents the how may map slots are already used for executing map tasks of job j. If the condition at line 8 of the pseudo-code is true, then line 9 of the pseudo-code determines if job j has an unlaunched map task t with data on node n—if so, then this map task t is launched with local data on node n (line 10 of the pseudo-code). The pseudo-code at lines 9-10 favor execution of a map task t that has data on node n—the availability of local data on node n for the map task t increases efficiency of execution since network communication is reduced or avoided in executing task t on node n.

However, if there is no map task t with local data on node n, line 11 of the pseudo-code checks if job j has unlaunched map task t—if so, then map task t is launched on node n (line 12 of the pseudo-code). Note that the map task t launched at line 12 may not have local data on node n.

Line 15 of the pseudo-code checks to see if there are any finished map tasks for job j (based on determining if FinishedMapsⱼ>0)—this check is performed since reduce tasks are performed after at least one map task completes. The parameter FinishedMapsⱼ indicates a number of map tasks that have completed. Also, line 15 checks to determine if free slot (s) is a reduce slot, and if the number of reduce slots used by job j (RunningReducesⱼ) is less than rj—if all three conditions of line 15 are true, then an unlaunched reduce task t from job j is launched (lines 16-17 of the pseudo-code).

Line 22 of the pseudo-code checks (at 514) to see if any task (map task or reduce task) has completed in node n. If so, then the minimum allocation of map slots and reduce slots (mⱼ, rⱼ) may be recomputed (at 516) based on a current time, a current progress of job j, and the deadline of job j (line 23 of the pseudo-code). The recomputing of the minimum allocation of map and reduce slots allows the system to ensure that the job j has sufficient resources to meets its deadline, given the progress of the job j. At any given point in time, the number of available map and/or reduce slots may be less than the number of map and reduce slots specified by a minimum allocation for job j. As a result, the job j may not be able to progress as quickly as anticipated, since insufficient resources are assigned to the job. The recomputation of the resource allocation for job j increases the likelihood that job j will be executed in time to meets its respective deadline.

Machine-readable instructions described above (including the various modules depicted in FIG. 1 and the pseudo-code depicted above) are loaded for execution on a processor (such as 124 in FIG. 1). A processor may include a microprocessor, microcontroller, processor module or subsystem, programmable integrated circuit, programmable gate array, or another control or computing device.

Data and instructions are stored in respective storage devices, which are implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

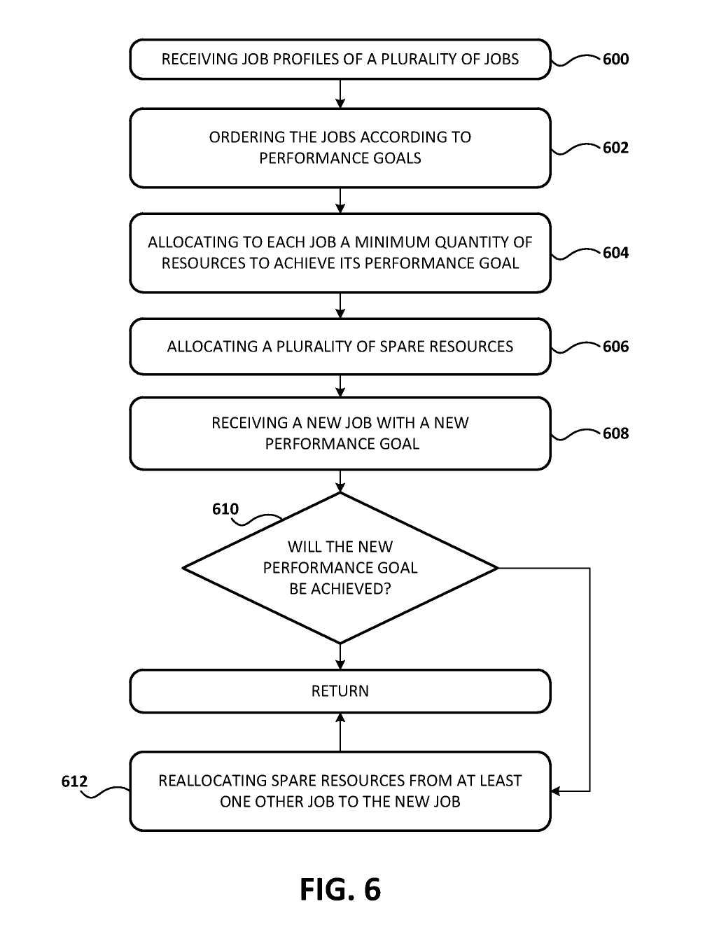

Another exemplary method which may be performed by various modules in the master node 110 of FIG. 1A is depicted in the flow chart of FIG. 6. The method includes receiving 600 job profiles of respective jobs. Each of the job profiles describes characteristics of map tasks and reduce tasks. The map tasks produce intermediate results based on input data, and the reduce tasks produce an output based on the intermediate results.

The exemplary method continues with ordering 602 the jobs according to performance goals of respective ones of the jobs into a hierarchy. The performance goals may be ordered, for example, based on deadlines with the most urgent deadline being at the top of the hierarchy. The exemplary process proceeds with allocating 604 to each of the jobs a minimum quantity of resources necessary to achieve the corresponding performance goal based on the corresponding job profile. The resources may be, for example, maps slots and reduce slots in at least one slave node 112.

The method then proceeds with allocating 606 a plurality of spare resources to at least one of the jobs. The spare resources may be additional map slots and reduce slots after the minimal amount of resources have been allocated to achieve each of the jobs' performance goals.

After the spare resources have been allocated, the method proceeds with receiving 608 a new job profile of a new job having a new performance goal. Next, the process proceeds with determining 610 whether the new performance goal of the new job may be achieved without deallocating the spare resources from the other jobs. For example, the system determines whether it may achieve the new performance goal only through the allocation of spare resources to the new job after those spare resources finish their respective tasks. If the performance goal of the new job cannot be met solely without additional resources, then the method continues with reallocating 612 spare resources from at least one of the other jobs to the new job to achieve the new performance goal without compromising the other performance goals of the other jobs. Since only spare resources are re-allocated, the processing of the new job will not compromise the system's ability to achieve the performance goals of the other jobs.

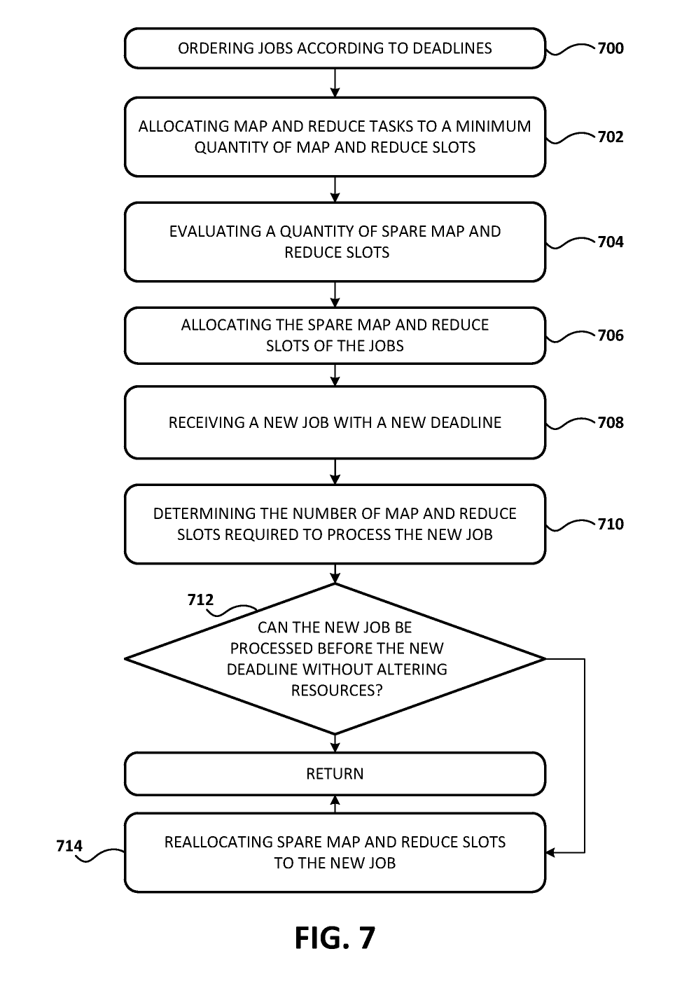

Yet another exemplary method which may be performed by various modules in the master node 110 of FIG. 1A is depicted in the flow chart of FIG. 7. The exemplary method of FIG. 7 is for processing workloads in a MapReduce environment using a system. The method includes ordering 700 a plurality of jobs according to deadline with the jobs having earlier deadlines receiving priority over the jobs having later deadlines. Each of the jobs which is allocated has a plurality of map tasks and a plurality of reduce tasks.

The exemplary method includes allocating 702 map tasks and reduce tasks to a minimum quantity of maps slots and reduce slots to each of the jobs to complete each of the jobs within its respective deadline. The method then continues with evaluating 704 with the system a quantity of spare map slots and reduce slots. The spare map and reduce slots are the additional slots not allocated to any jobs after each of the job has had enough resources allocated to it to be completed before its respective deadline.

The method then continues with allocating 706 map tasks and reduce tasks of at least one of the jobs to the spare map slots and reduce slots. Thus, additional resources are allocated to at least one of the jobs to complete some of the jobs before its deadline. The method proceeds with receiving 708 a new job having a new deadline. The method then continues with analyzing 710 the new job to determine the quantity of map slots and reduce required to process the new job. Next, the method proceeds with determining 712 whether the new job may be processed before the new deadline through the allocation of spare map slots and spare reduce slots after those slots have finished processing their respective map tasks and reduce tasks of the other jobs. If the new job cannot be completed before its deadline, then the method continues with reallocating 714 a plurality of spare map slots and a plurality of spare reduce slots to the new job to complete the new job before the new deadline.

Another example technique performed by the master node 110 (FIG. 1) is set forth in the following process.

```
1: ON THE ARRIVAL OF NEW JOB J :
2: (MinMapsⱼ, MinReducesⱼ) ← ComputeMinResources (J, D_{J})
3: // Do we have enough resources to meet this job's deadline right now?
4: if MinMaps_{J} < F_{M} and MinReduces_{J} < F_{R} then return
5: // Will we have enough resources in the future?
6: Sort jobs by increasing task durations
7: for each job_{J} in jobs do
8:  if CompletedMapsⱼ < N_{M}^{j} and MinMaps_{J} > F_{M} then
9:  // Job_{J} is in the Map stage and J is short on map slots
10:  ExtraMaps_{J} ← RunningMaps_{J} − MinMaps_{J}
11:  F_{M ←} F_{M} + ExtraMaps_{J}
12:  (MinMaps_{J}, MinReduces_{J}) ← ComputeMinResources( J,
            D_{J -} M_{AVG}^{j})
13:  if MinMaps_{J} < F_{M} and MinReduces_{J} < F_{R} then return
14:  else if CompletedMaps_{J} = N_{M}^{j} and MinReduce_{J} > F_{R} then
15:  // Job_{J} is in the Reduce stage and J is short on reduce slots
16:  ExtraReduces_{J} ←RunningReduces_{J} − Minreduces_{J}
17:  FR←FR + ExtraReduces_{J}
18:  (MinMaps_{J}, MinReduces_{J}) _{←} ComputeMinresources (J,
          D_{J -} R_{AVG}^{j})
19:  if MinMaps_{J} < F_{M} and MinReduces_{J} < F_{R} then return
20:  end if
21: end for
22: //Not enough resources to meet deadline in future, need to kill tasks
23: for each job_{J} in jobs do
24:  if RunningMaps_{J} > MinMaps_{J} then
25:  F_{M} ← F_{M} + RunningMaps_{J} − MinMaps_{J}
26:  KillMapTasks(_{J}, RunningMaps_{J} − MinMaps_{J})
27:  if MinMaps_{J} < F_{M} then return
28:  end if
29: end for
30: ON RELEASE OF A MAP SLOT:
31: Find job_{J} among jobs with earliest deadline and CompletedMaps_{J} <
    N_{M}^{j} and RunningMaps_{J} < MinMaps_{J} return_{J}
32: if such job_{J} is not found, then return job_{J} with the earliest deadline
    with CompletedMaps_{J} < N_{M}^{j}
33: ON RELEASE OF A REDUCE SLOT:
34: Find job_{J} among jobs with earliest deadline and CornpletedMaps_{J =}
    N_{M}^{j} and CompletedReduces_{J} < N_{R}^{j} and RunningReduces_{J} <
    MinReduces_{J} return_{J}
35: if such job_{J} is not found, then return job_{J} with the earliest deadline
  with CompletedMaps_{J} = N_{M}^{j} and CompletedReduces N_{R}^{j}
```

We claim:

1. A method of managing workloads for MapReduce environments, comprising:
receiving job profiles of respective jobs, wherein each job profile has map tasks and reduce tasks;
allocating to each of the jobs a minimum quantity of map and reduce slots necessary to achieve all of the performance goals;
allocating a plurality of spare map and reduce slots to at least one of the jobs to process the map and reduce tasks;
receiving a new job profile of a new job having new map tasks, new reduce tasks, and a new performance goal; and
reallocating at least a minimum quantity of spare map and reduce slots from at least one of the other jobs to the new job to process the new map and reduce tasks and achieve the new performance goal.

2. The method of claim 1, wherein the performance goals comprise deadlines of the corresponding jobs, and further including ordering the jobs into a hierarchy according to the deadlines.

3. The method of claim 2, wherein ordering the jobs provides an order of jobs where a given one of the jobs with an earliest deadline from among the deadlines of the jobs is first in the hierarchy.

4. The method of claim 1, wherein determining the minimum allocation of the map and reduce slots uses a Lagrange's multiplier technique.

5. The method of claim 1, wherein determining the respective allocation of the map and reduce slots for each of the jobs comprises determining the respective allocation of map slots and reduce slots, wherein the map tasks of the respective job are performed in the map slots to produce intermediate results, and the reduce tasks of the respective job are performed in the reduce slots to produce an output.

6. The method of claim 5, wherein the map slots and reduce slots are provided in a plurality of nodes of a distributed computing platform.

7. The method of claim 1 wherein determining the allocation of map and reduce slots for a particular one of the jobs uses a performance model that calculates a performance parameter based on the characteristics of the job profile for the particular job, a number of the map tasks of the particular job, a number of the reduce tasks of the particular job, and an allocation of map and reduce slots for the particular job.

8. The method of claim 1, further comprising:
upon completion of a given one of the scheduled tasks, recomputing the allocation of the map and reduce slots for the job that the given scheduled task is part of.

9. A system including a plurality of worker nodes having map and reduce slots and a computer having a computer readable storage medium encoded with a computer program, the computer program comprising instructions that, when executed by a processor, causes the processor to:
schedule a minimum quantity of map and reduce tasks of a plurality of jobs to the map and reduce slots of the worker nodes to achieve the performance goal of each of the jobs;
schedule map tasks and reduce tasks to a quantity of spare map and reduce slots of the worker nodes;
receive at least one new job having new map tasks, new reduce tasks, and a new performance goal; and
reallocate a plurality of spare map and reduce slots from the other jobs to the new job in order to achieve the new performance goal.

10. The system of claim 9, wherein the map slots perform respective ones of the map tasks in map stages of the plurality of jobs to produce intermediate results, and the reduce slots perform respective ones of the reduce tasks in reduce stages of the plurality of jobs to produce an output.

11. The system of claim 10, wherein the determined allocation of resources for each of the plurality of jobs includes an allocation having a minimum number of a total number of map slots and reduce slots that allows the respective job to meet the corresponding performance goal.

12. The system of claim 9, wherein the performance goals include deadlines of the jobs, and the processor orders the jobs according to the deadlines such that jobs with earlier deadlines are ahead of jobs with later deadlines, and wherein the scheduling of the tasks of the plurality of jobs for execution processes the jobs according to the order.

13. The system of claim 9, wherein the scheduling of the tasks provides higher priority to tasks having local data on a particular one of the worker nodes that is being considered for scheduling tasks.

14. A method of processing workloads in MapReduce environments, comprising:
ordering a plurality of jobs according to deadline with the jobs having earlier deadlines receiving priority over the jobs having later deadlines, wherein each of the jobs has a plurality of map tasks and a plurality of reduce tasks;
allocating map tasks and reduce tasks to a minimum quantity of maps slots and reduce slots to each of the jobs to complete each of the jobs within its respective deadline;
evaluating with the system a quantity of spare map slots and reduce slots;
allocating map tasks and reduce tasks of at least one of the jobs to the spare map slots and reduce slots;
receiving a new job having a new deadline;
analyzing the new job to determine the quantity of map slots and reduce required to process the new job;
determining whether the new job can be processed before the new deadline through the allocation of spare map slots and spare reduce slots after those slots finish processing their respective map tasks and reduce tasks;
reallocating a plurality of spare map slots and a plurality of spare reduce slots to the new job to complete the new job before the new deadline.
